(19) United States
(12) Patent Application Publication
(10) Pub. No.: US 2005/0250899 A1
(43) Pub. Date: Nov. 10, 2005

(54) Use of copolymers stabilized with a protective colloid in cement-free or low-cement coating materials

(75) Inventors: Andreas Bacher, Burghausen (DE); Hans-Peter Weitzel, Reischach (DE); Franz Jodlbauer, Marktl (DE); Harald Zeh, Burghausen (DE)

Correspondence Address: BROOKS KUSHMAN P.C., 1000 TOWN CENTER, TWENTY-SECOND FLOOR, SOUTHFIELD, MI, 48075, US

(73) Assignee: Wacker Polymer Systems GmbH & Co. KG, Burghausen (DE)

(21) Appl. No.: 11/112,778

(22) Filed: Apr. 22, 2005

(30) Foreign Application Priority Data
May 6, 2004 (DE) 10 2004 022 405.6

(51) Int. Cl. C08L 31/02

(52) U.S. Cl. 524/563; 524/556

(57) ABSTRACT

The present invention relates to the use of copolymers stabilized with a protective colloid, in the form of their polymer powders redispersible in water or in the form of their aqueous polymer dispersions, in cement-free or low-cement coating materials, wherein the copolymer is obtainable by free radical polymerization, in water, of a) from 35 to 65% by weight of vinyl acetate, b) from 5 to 20% by weight of ethylene, c) from 40 to 70% by weight of vinyl esters of alpha-branched, tertiary monocarboxylic acids having 5 to 15 carbon atoms, and optionally d) from 0.1 to 10% by weight of further copolymerizable, ethylenically unsaturated comonomers, the data in % by weight totaling 100% by weight.

### BACKGROUND OF THE INVENTION

1. Field of the Invention

The invention relates to the use of copolymers stabilized with a protective colloid, in the form of redispersible polymer powders in cement-free or low-cement plaster materials, in particular in renders and reinforcing renders.

2. Background Art

EP 0513889 A1 describes the use of protective colloid-stabilized copolymers of a vinyl ester of branched, tertiary carboxylic acids having 10 carbon atoms, vinyl pivalate, and vinyl acetate, as binders in coating materials. EP 0 516 201 A1 discloses emulsifier-stabilized copolymers of vinyl pivalate (VeoVa 5), a vinyl ester of branched, tertiary carboxylic acids having 10 carbon atoms (VeoVa 10) and vinyl acetate, which are used in coating materials. Emulsifier-stabilized vinyl acetate/ethylene/vinyl pivalate copolymers as binders for coating materials are disclosed in EP 0 518 406 A1. EP 0 902 769 B1 discloses copolymers of vinyl acetate, ethylene and vinyl esters of branched, tertiary carboxylic acids having 5 to 11 carbon atoms as additives for improving the extensibility of building materials based on mineral binders, in particular in sealing slurries.

### SUMMARY OF THE INVENTION

It was an object of the present invention to provide coating materials which, even without the addition of cement, lead to coatings such as paints and renders having high mechanical strength and high water resistance. this and other objects are achieved through the use of aqueous polymerized, protective colloid-stabilized copolymers of vinyl acetate, ethylene, vinyl esters of α-branched tertiary carboxylic acids and further copolymerizable molecules within the compositional ranges disclosed herein.

### DETAILED DESCRIPTION OF THE PREFERRED EMBODIMENT(S)

The invention thus relates to the use of copolymers stabilized with a protective colloid, in the form of their polymer powders redispersible in water or in the form of their aqueous polymer dispersions, in cement-free or low-cement coating materials, wherein the copolymer is obtainable by free radical polymerization, in water, of
a) from 35 to 65% by weight of vinyl acetate,
b) from 5 to 20% by weight of ethylene,
c) from 40 to 70% by weight of vinyl esters of alpha-branched, tertiary monocarboxylic acids having 5 to 15 carbon atoms, and
d) optionally from 0.1 to 10% by weight of further copolymerizable, ethylenically unsaturated comonomers,
   the percents by weight totaling 100%.

The copolymers preferably contain from 40 to 50% by weight of vinyl acetate units, from 5 to 15% by weight of ethylene units and from 40 to 50% by weight of units of vinyl esters of alpha-branched, tertiary monocarboxylic acids having 5 to 15 carbon atoms. The most preferred amounts of vinyl acetate and α-branched vinyl esters is, in each case, from 45 to 50 weight percent.

Preferred vinyl esters c) are those of alpha-branched, tertiary monocarboxylic acids having 9 to 15 carbon atoms, most preferably, alpha-branched, tertiary monocarboxylic acids having 10 carbon atoms, for example VeoVa 10 (Veo Va is a trade name of Polymer Solutions).

Suitable comonomers d) are ethylenically unsaturated mono- and dicarboxylic acids, preferably acrylic acid, methacrylic acid, fumaric acid and maleic acid; ethylenically unsaturated carboxamides and carboxylic acid nitriles, preferably acrylamide and acrylonitrile; ethylenically unsaturated sulfonic acids and salts thereof, preferably vinylsulfonic acid, and 2-acrylamido-2-methylpropanesulfonic acid. Further examples are precrosslinking comonomers such as polyethylenically unsaturated comonomers, for example divinyl adipate, diallyl maleate, allyl methacrylate or triallyl cyanurate, or postcrosslinking comonomers, for example N-methylolacrylamide (NMA), N-methylolmethacrylamide, alkyl ethers such as the isobutoxy ether, or esters, of N-methylolacrylamide, of N-methylolmethacrylamide and of N-methylolallylcarbamate. Epoxide-functional comonomers, such as glycidyl methacrylate and glycidyl acrylate, are also suitable. Further examples are silicon-functional comonomers, such as acryloyloxypropyltri(alkoxy)- and methacryloyloxypropyltri(alkoxy)silanes, vinyltrialkoxysilanes and vinylmethyldialkoxysilanes. These monomers may be used individually or in combination, and to the exclusion of any given monomer or monomers as well.

In general, the glass transition temperature Tg of the copolymers is from −10° C. to 15° C.

The preparation of the copolymers is effected by emulsion polymerization or suspension polymerization in the presence of protective colloids, optionally in combination with emulsifiers, preferably by emulsion polymerization, the polymerization temperature generally being from 40° C. to 100° C., preferably from 60° C. to 90° C., a pressure between 5 bar and 100 bar being employed. The initiation of the polymerization is effected using the water-soluble or monomer-soluble initiators or redox initiator combinations customary for emulsion polymerization or suspension polymerization. Examples of water-soluble initiators are sodium persulfate, hydrogen peroxide and azobisisobutyronitrile. Examples of monomer-soluble initiators are diacetyl peroxydicarbonate, dicyclohexyl peroxydicarbonate and benzoyl peroxide. The initiators are generally used in amounts of from 0.01 to 0.5% by weight, based on the total weight of the monomers. Redox initiators commonly used are combinations of initiators with reducing agents. Suitable reducing agents are, for example, sodium sulfite, sodium hydroxymethanesulfinate and ascorbic acid. The amount of reducing agent is preferably from 0.01 to 0.5% by weight, based on the total weight of the monomers.

For controlling the molecular weight, regulating substances (chain transfer agents) can be used during the polymerization. If regulators are used, these are usually employed in amounts of from 0.01 to 5.0% by weight, based on the monomers to be polymerized, and are metered separately or premixed with reaction components. Examples of such substances are n-dodecyl mercaptan, tert-dodecyl mercaptan, mercaptopropionic acid, methyl mercaptopropionate, isopropanol and acetaldehyde. Preferably, no regulating substances are used.

Suitable protective colloids are partly hydrolyzed or completely hydrolzyed polyvinyl alcohols; polyvinylpyrrolidones; polyvinylacetals; polysaccharides in water-soluble form such as starches (amylose and amylopectin); celluloses and the carboxymethyl, methyl, hydroxyethyl and hydroxypropyl derivatives thereof; proteins such as casein or caseinate, soybean protein and gelatin; ligninsulfonates; synthetic polymers such as poly(meth)acrylic acid, copolymers of (meth)acrylates with carboxyl-functional comonomer units, poly(meth)acrylamide, polyvinylsulfonic acids and the water-soluble copolymers thereof; melamine formaldehyde sulfonates, naphthalene formaldehyde sulfonates, styrene/maleic acid copolymers and vinyl ether/maleic acid copolymers. Partly hydrolyzed or completely hydrolyzed polyvinyl alcohols are preferred. Partly hydrolyzed polyvinyl alcohols having a degree of hydrolysis of from 80 to 95 mol % and a Höppler viscosity, in 4% strength aqueous solution, of from 1 to 30 mPa.s (Höppler method at 20° C., DIN 53015) are particularly preferred.

Polymerization is preferably effected without addition of emulsifier. Suitable emulsifiers, which can optionally be used in an amount of from 0.5 to 10% by weight based on the weight of the monomers, are anionic, cationic and nonionic emulsifiers, for example anionic surfactants such as alkylsulfates having a chain length of 8 to 18 carbon atoms, alkyl or alkylaryl ether sulfates having 8 to 18 carbon atoms in the hydrophobic radical and up to 40 ethylene oxide or propylene oxide units, alkyl or alkylarylsulfonates having 8 to 18 carbon atoms, esters and monoesters of sulfosuccinic acid with monohydric alcohols or alkylphenols, or nonionic surfactants, such as alkylpolyglycol ethers or alkylarylpolyglycol ethers having 8 to 40 ethylene oxide units.

After the end of the polymerization, postpolymerization can be effected for removal of residual monomers with the use of known methods, for example by postpolymerization initiated with a redox catalyst. Volatile residual monomers can also be removed by means of distillation, preferably under reduced pressure, and optionally by passing inert entraining gases such as air, nitrogen or steam through or over. The aqueous dispersions obtainable thereby have a solids content of from 30 to 75% by weight, preferably from 50 to 60% by weight.

For the preparation of the polymer powder compositions redispersible in water, the aqueous dispersions, optionally after addition of protective colloids as an atomizing assistant, are dried, for example by means of fluidized-bed drying, freeze drying or spray drying. The dispersions are preferably spray-dried. The spray drying is effected in conventional spray drying units, it being possible for the atomization to be effected by means of single-medium, binary or multi-medium nozzles or using a rotating disk. The outlet temperature is generally chosen to be in the range from 45° C. to 120° C., preferably from 60° C. to 90° C., depending on the spray drying unit, the Tg of the resin, and the desired degree of drying.

As a rule, the atomizing assistant is used in a total amount of from 3 to 30% by weight, based on the polymeric components of the dispersion. This means that the total amount of protective colloid before the drying process should be at least 3 to 30% by weight, based on the proportion of polymer; from 5 to 20% by weight, based on the proportion of polymer, is preferably used.

Suitable atomizing assistants are, for example, the abovementioned protective colloids. Preferably, no further protective colloids in the form of polyvinyl alcohols are used as atomizing assistants.

During the atomization, a content of up to 1.5% by weight, based on the base polymer, of antifoam has often proven to be advantageous. In order to increase the shelf life by improving the stability against blocking, particularly in the case of powders having a low glass transition temperature, the powder obtained can be treated with an antiblocking agent (anticaking agent), preferably up to 30% by weight, based on the total weight of polymeric components. Examples of antiblocking agents are Ca and Mg carbonate, talc, gypsum, silica, kaolins, and silicates, preferably having particle sizes in the range from 10 nm to 10 μm.

The viscosity of the feed to be atomized is adjusted by means of the solids content so that a value of<500 mPa.s (Brookfield viscosity at 20 revolutions and 23° C.), preferably<250 mPa.s, is obtained. The solids content of the dispersion to be atomized is>35%, preferably>40%.

The polymer powders redispersible in water are used in low-cement, preferably cement-free, plaster materials, in particular in renders and reinforcing renders.

For the preparation of the coating materials, the polymer powder is mixed with the further components of the formulation, such as filler, pigment and further additives, in suitable mixers and is homogenized. The dispersion powder can optionally also be added at the building site. Preferably, a dry mixture is prepared and the water required for processing is added immediately before the processing.

The protective colloid-stabilized copolymers are suitable for use in cement-free or low-cement formulations, preferably for use in cement-free formulations. Low-cement formulations are those having a cement fraction of up to 10% by weight. Typical formulations contain from 0 to 10% by weight of cement, from 5 to 95% by weight of fillers, such as quartz sand, calcium carbonate or talc, preferably from 50 to 95% by weight, and most preferably 70 to 95% by weight, from 0.1 to 2% by weight of thickeners, such as cellulose ethers, sheet silicates or polyacrylates, from 0.1 to 60% by weight of the protective colloid-stabilized copolymers in the form of the polymer powder, preferably from 4 to 40% by weight, and optionally further additives for improving stability, processibility, open time and water resistance. The data in % by weight are always based on 100% by weight dry mass of the formulation. The dry compositions may also, in addition to fillers, contain fibrous substances such as cellulose fibers, glass fibers, etc.

The examples which follow serve for further illustration of the invention:

### EXAMPLE 1

Preparation of the Dispersion:

104 kg of demineralized water, 101 kg of a 20% by weight aqueous solution of a polyvinyl alcohol having a degree of hydrolysis of 88 mol % and a Höppler viscosity of 4 mPa.s , 71.1 kg of vinyl acetate, and 71.1 kg of VeoVa 10 were initially introduced into a 600 1 autoclave. The pH was adjusted to 4.0 with formic acid and the autoclave was evacuated. 26 bar ethylene was then forced in at 55° C., which corresponds to an amount of ethylene of 19 kg.

To initiate the polymerization, the initiator doses, 3% strength aqueous tert-butyl hydroperoxide solution and 5% strength aqueous Brüggolit solution were metered, each at 1740 g/h. The internal temperature was limited to 75° C. by external cooling. 35 minutes after the beginning of the reaction, the ethylene pressure was increased to 35 bar and the metering of vinyl acetate and VeoVa 10 was begun. 47.4 kg of vinyl acetate and 47.4 kg of VeoVa 10 were metered at a rate of 19.0 kg/h each. At the same time, 28.4 kg of a 12.3% strength aqueous solution of a polyvinyl alcohol having a degree of hydrolysis of 88 mol % and a Höppler viscosity of 4 mPa.s were metered at a rate of 11.4 kg/h. Ethylene was metered up to an amount of 28 kg. After the end of the reaction, cooling was effected, excess ethylene was let down and the polymer was subjected to postpolymerization to remove residual monomer. For the postpolymerization, 1000 g of tert-butyl hydroperoxide, as a 10% strength aqueous solution, and 1600 g of Brüggolit, as a 5% strength aqueous solution, were added in succession. The dispersion was then filtered via a 500 μm sieve.

A dispersion having the following characteristic data was obtained: Copolymer of 45% by weight of vinyl acetate, 45% by weight of VeoVa10, 10% by weight of ethylene.

| | |
|---|---|
| Solids content: | 55.1% |
| Viscosity (Brookfield 20 rpm): | 1530 mPa · s |
| pH: | 3.9 |
| Minimum film formation temperature: | 0° C. |
| Tg: | −1° C. |

Powder preparation:

1% by weight (solid/solid) of polyvinyl alcohol having a degree of hydrolysis of 88 mol % and a Höppler viscosity of 4 mPa.s and 3% by weight (solid/solid) of polyvinyl alcohol having a degree of hydrolysis of 88 mol % and a Höppler viscosity of 13 mPa.s were added to the dispersion, and dilution was effected with water to an atomization viscosity of 250 mPa.s. The dispersion was then sprayed by means of a binary nozzle. Air precompressed to 4 bar served as an atomizing component, and the drops formed were dried by the cocurrent method using air heated to 125° C. 10% by weight of commercial antiblocking agent (kaolin) were added to the dry powder obtained.

### COMPARATIVE EXAMPLE 1

A polyvinyl alcohol-stabilized redispersion powder based on a copolymer comprising 70% by weight of vinyl acetate, 15% by weight of ethylene and 15% by weight of VeoVa10 was prepared analogously to the procedure in example 1.

Testing:

The copolymers were used in the form of their polymer powders redispersible in water, in the following dry mortar formulation.

Formulation:

387.0 parts by weight of calcium carbonate (Omyacarb 130 GU)
45.0 parts by weight of calcium carbonate (Omyacarb 5 GU)
380.0 parts by weight f sand (Calcilit 0.1-0.5)
50.0 parts by weight of sand (quartz sand No. 12)
40.0 parts by weight of dispersion powder (example 1 or comparative example 1)
30.0 parts by weight of pigment (Kronos 2059)
4.5 parts by weight of antifoam (Agitan P 801)
2.5 parts by weight of cellulose fiber (Arbocel BC 1000)
1.0 parts by weight of cellulose ether (Walocel MW 40000 PFV 50)
5.0 parts by weight of bentonite (Bentone EW)

The pulverulent mixture was stirred with water to give a pasty material and was spread 3 mm thick on a 6 cm thick polystyrene foam sheet of type EPS 15 B1 over an area of 5×5 cm² with the aid of a template. After a drying time of 25 days under standard temperature and humidity conditions, a sheet-like anchor tie was adhesively bonded to the coated part of the polystyrene foam sheet with the aid of a reaction resin adhesive and, on the 26th day, the test specimen was placed in water with the coated side facing downward.

After exactly 48 hours, the test specimen was removed from the water, and the adhesive strength in N/mm² was determined immediately using a Herion apparatus. It was also determined whether a fragment was also torn out from the polystyrene foam sheet in this tensile test, which would mean that the adhesive strength in this region is higher than the strength of the polystyrene foam sheet. This torn-out fragment was stated in % of the total area.

Both the adhesive strength, measured in N/mm², and the fragment torn out from the substrate served for assessing the adhesion.

The results are summarized in Table 1.

TABLE 1

| | Example 1 | Comparative Example 1 |
|---|---|---|
| Adhesive strength | 0.1 | 0.04 |
| test [N/mm²] | | |
| Torn-out | 74 | 0 |
| polystyrene | | |
| fragment [%] | | |

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A cement-free or low-cement dry plaster coating composition, comprising from 5 to 95% by weight filler(s), 0.1 to 2% by weight thickener(s), 0 to 10% by weight cement, and from 0.1 to 60% by weight of a redispersible, protective colloid stabilized copolymer powder obtained by free radical polymerization, in water, of
a) from 35 to 65% by weight of vinyl acetate,
b) from 5 to 20% by weight of ethylene,
c) from 40 to 70% by weight of vinyl esters of alpha-branched, tertiary monocarboxylic acids having 5 to 15 carbon atoms, and
d) optionally from 0.1 to 10% by weight of further copolymerizable, ethylenically unsaturated comonomers,
followed by removing water to produce a dry powder, the weight percentages a) to d) totaling 100% by weight.

2. The dry plaster composition of claim 1, wherein the copolymer contains from 40 to 50% by weight of vinyl acetate units, from 5 to 15% by weight of ethylene units and from 40 to 50% by weight of units of alpha-branched, tertiary monocarboxylic acids having 5 to 15 carbon atoms.

3. The dry plaster composition of claim 2 which contains from 45 to 50 weight percent vinyl acetate and 45-50 weight percent of units of alpha-branched, tertiary monocarboxylic acids having 5 to 15 carbon atoms.

4. The dry plaster composition of claim 1, wherein the copolymers are stabilized exclusively with a protective colloid.

5. The dry plaster composition of claim 2, wherein the copolymers are stabilized exclusively with a protective colloid.

6. The dry plaster composition of claim 1, wherein partly hydrolyzed polyvinyl alcohols having a degree of hydrolysis of from 80 to 95 mol % and a Höppler viscosity, in 4% strength aqueous solution, of from 1 to 30 mPa.s are used as the protective colloid.

7. The dry plaster composition of claim 2, wherein partly hydrolyzed polyvinyl alcohols having a degree of hydrolysis of from 80 to 95 mol % and a Höppler viscosity, in 4% strength aqueous solution, of from 1 to 30 mPa.s are used as the protective colloid.

8. The dry plaster composition of claim 3, wherein partly hydrolyzed polyvinyl alcohols having a degree of hydrolysis of from 80 to 95 mol % and a Höppler viscosity, in 4% strength aqueous solution, of from 1 to 30 mPa.s are used as the protective colloid.

9. The dry plaster composition of claim 4, wherein partly hydrolyzed polyvinyl alcohols having a degree of hydrolysis of from 80 to 95 mol % and a Höppler viscosity, in 4% strength aqueous solution, of from 1 to 30 mPa.s are used as the protective colloid.

10. The dry plaster composition of claim 1, which is a render or a reinforcing render.

11. The dry plaster composition claim 1, wherein said coating composition comprises a calcium carbonate plaster.

12. The dry plaster composition of claim 1 wherein said filler is present in an amount of 50 to 95% by weight.

13. The dry plaster composition of claim 1 wherein said filler is present in an amount of 70 to 95% by weight.

14. The dry plaster composition of claim 1, wherein said filler comprises calcium carbonate and sand.
